(19) United States
(12) Patent Application Publication
(10) Pub. No.: US 2009/0144538 A1
(43) Pub. Date: Jun. 4, 2009

(54) Patch installation at boot time for dynamically installable, piecemeal revertible patches

(76) Inventors: Kenneth J. Duda, Menlo Park, CA (US); Edward R. Swierk, Mountain View, CA (US)

Correspondence Address: LUMEN PATENT FIRM, 2345 YALE STREET, SECOND FLOOR, PALO ALTO, CA, 94306, US

(21) Appl. No.: 12/291,161

(22) Filed: Nov. 5, 2008

Related U.S. Application Data
(60) Provisional application No. 61/001,958, filed on Nov. 5, 2007.
(60) Provisional application No. 61/001,959, filed on Nov. 5, 2007.

(51) Int. Cl. G06F 9/445

(52) U.S. Cl. 713/2; 713/1

(57) ABSTRACT

A method for booting a computer operating system is provided. A boot loader is loaded from a first flash memory to a random access memory and executed. In one embodiment, the boot loader loads from a second flash memory to a random access memory an operating system file system image archive, installs the operating system file system image archive as a root file system, loads from the second flash memory multiple operating system patches stored separately from the base operating system file system image archive, and installs the multiple operating system patches over the root file system. In another embodiment, the boot loader loads and executes an initialization script that performs the operations instead of the boot loader.

### CROSS-REFERENCE TO RELATED APPLICATIONS

This application claims priority from U.S. Provisional Patent Application 61/001,958 filed Nov. 5, 2007, which is incorporated herein by reference. This application also claims priority from U.S. Provisional Patent Application 61/001,959 filed Nov. 5, 2007, which is incorporated herein by reference.

### FIELD OF THE INVENTION

The present invention relates generally to computer operating systems. More specifically, it relates to methods for patch installation at boot time for dynamically installable, piecemeal revertible patches.

### BACKGROUND OF THE INVENTION

In standard practice, when an operating system is patched, a patch alters the persistent representation of the operating system itself. For example, when patching Windows XP security holes, certain system DLLs are replaced by newer versions. The modified version of the operating system is then saved on a persistent storage device, such as a hard disk, and loaded on the next boot. When patching Red Hat Linux, a new RPM is installed directly on the hard disk, replacing, removing, or creating files, leaving no reliable path to get back to the previous image. In the case of rpms, in principle one can “rpm -U --oldpackage” to downgrade to a prior version of the rpm, but this mechanism is fragile due to details like post-install scripts. Other operating systems checkpoint all or part of the disk at certain intervals and allow rolling back the entire disk or individual files to a prior checkpoint. Undoing a patch requires the user to recall when the patch was installed and which files it affected. In the event that a patch unexpectedly disrupts operation, it can be difficult to revert quickly and easily to a prior version of the operating system.

### SUMMARY OF THE INVENTION

In one aspect, the present invention provides a method to patch an operating system so that individual patches may be easily and reliably undone. The patches are stored as individual units in persistent storage, separate from the operating system. Then, at boot time, the running operating system image is updated with the patch, but its persistent representation is left unchanged. This way, the patch may be undone simply by marking it inactive and rebooting.

The key advantage compared to prior art is the ability to reliably restore the system to the precise state it was in prior to applying a patch by simply deactivating the patch. Another advantage is that if a set of patches has been applied, any subset of them may be undone by selectively deactivating each patch, e.g., using a patch configuration file.

To provide support for patching without rebooting, the act of activating a patch may be augmented to install the patch contents on top of the running system.

One may gain additional benefit by providing support for dynamically activating and deactivating patches. Activation includes arranging for the patch to be applied on next system boot, and also applying the patch on the running system by updating files included in the patch and running activation scripts (if any) included in the patch. Activation scripts restart any processes affected by the patch's file updates.

Dynamic deactivation includes arranging for the patch to not be applied on next system boot, and also undoing the effects of the patch within the running system, by recovering files named in the patch from the original boot image, updating them with any other active patches that affect them, and running a deactivation script associate with the patch. The deactivation scripts restart any processes affected by the patch's file updates.

In one aspect, a method for booting a computer operating system is provided. A boot loader is loaded from a first flash memory to a random access memory and executed. In one embodiment, the boot loader loads from a second flash memory to a random access memory an operating system file system image archive, installs the operating system file system image archive as a root file system, loads from the second flash memory multiple operating system patches stored separately from the base operating system file system image archive, and installs the multiple operating system patches over the root file system. In another embodiment, the boot loader loads and executes an initialization script that performs the operations instead of the boot loader. The method may be performed on a computing apparatus that includes a digital microprocessor, random access memory, input/output interfaces, a first flash memory, and second flash memory. The first flash memory contains the boot loader, while the second flash memory contains the base operating system file system image archive and multiple operating system patches stored separately from the base operating system file system image archive.

### BRIEF DESCRIPTION OF THE DRAWINGS

FIG. 1 is a flow chart illustrating steps of receiving and storing a software update patch, according to an embodiment of the invention.

FIG. 2 is a flow chart illustrating steps of booting an operating system and installing patches during the boot process, according to an embodiment of the invention.

FIG. 3 is a block diagram of one embodiment of a computing system which may be used to implement the techniques of the invention.

### DETAILED DESCRIPTION

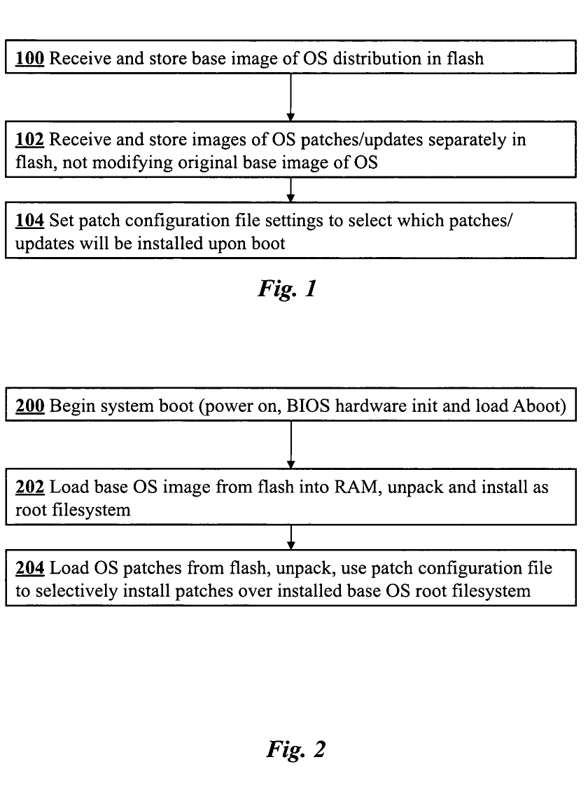

FIG. 1 shows steps performed by a computing system for receiving and storing operating system software and one or more software update patches, according to an embodiment of the invention. In step 100, a base software image of an operating system distribution is received and stored in a flash memory of the computing system. Preferably, the persistent operating system image is a gzipped cpio archive. Similarly, the patches are also stored in flash memory as separate software images in step 102. Significantly, the patches do not modify or alter the base OS software distribution at this stage. In step 104, a patch configuration file is set to indicate whether or not the patch should be installed during the boot process. The configuration file is preferably also stored in flash memory.

FIG. 2 illustrates the steps of booting an operating system and installing patches during the boot process, according to an embodiment of the invention. The boot process begins with step 200 in which hardware is initialized and a boot loader is loaded and executed. In step 202 the boot loader extracts initializations scripts from flash. The scripts read the operating system image from flash, uncompresses it, and stores it in RAM as a root file system. The operating system at this stage is a pristine version, unmodified by any patches or updates. In step 204 the patches are read from the flash memory, decompressed if needed, and installed in RAM over the root file system in accordance with the patch configuration file. This step may be performed, for example, by executing rc.aros, and using “rpm -U” to install the patch into the RAM file system. The rpm program transfers all of the files in patch into the root file system. Once the patches are installed, the boot process continues to boot additional software as necessary. In an alternate embodiment, the boot loader itself performs the above steps instead of the initialization script.

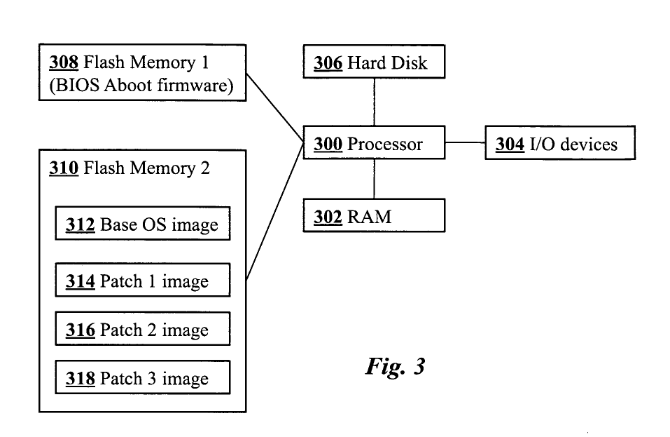

FIG. 3 is a block diagram of one embodiment of a computing system which may be used to implement the techniques of the invention. A processor 300 performs the basic central processing functions. A random access memory (RAM) 302 stores active programs, files, and other data. Input and output (I/O) devices 304 provide connections to network interfaces and other devices that provide data communication. A permanent storage medium 306, such as a hard disk, stores program and file data. Flash memory 308 stores boot loader instructions and other information used in the earliest stage of the boot process. Flash memory 310, which is preferably much larger in capacity, stores the base OS system image 312 and also stores one or more patches or updates as separate software image archives, e.g., patches 314, 316, 318. In a particular implementation, for example, flash 308 may be a 2-megabyte low-pin-count (LPC) BIOS flash, and flash 310 may be a standard 1-gigabyte system flash that holds the run-time software image, patches, and software configuration. The LPC flash 308 is typically written only during manufacturing. The system flash, on the other hand, may have the base OS image written during manufacturing. In addition, patches or updates can be written to flash 310 after the apparatus is put into service, as described above in relation to step 104 (FIG. 1).

By way of illustration, an example of a particular boot process will now be outlined.
(1) system powers on.
(2) BIOS initializes the hardware and boots a stage-1 Linux kernel (stored in BIOS flash 308, not upgradeable) called “Aboot”.
(3) Aboot reads boot configuration from the system flash 310. The boot configuration includes which OS software image to boot.
(4) Aboot extracts the stage-2 Linux kernel and initialization scripts from the base OS software image 312.
(5) Aboot executes the stage-2 Linux kernel and transfers control to the software initialization scripts.
(6) The initialization scripts unpack the root file system archive from the OS software image 312 into a RAM file system.
(7) The initialization scripts run rc.ros, which then applies the desired patches 314, 316, 318 to the RAM file system.
(8) The initialization scripts continue the remainder of the booting process.

To undo the patch, one merely comments out the “rpm -U” command and reboots. On this subsequent boot, the patch will not be applied to the RAM file system, so the system has been effectively reverted to its pre-patched state. In a preferred implementation, instead of following the above procedure to control whether the patch is installed or not during the boot process, a patch configuration file describes which patches should be installed on next boot and which should not.

In some cases, there may be dependencies among patches, e.g., a dependent patch B may require another patch A. In the event of such patch dependencies, the deactivation of a patch preferably automatically deactivates all its dependent patches as well. Alternatively, patch dependencies may be avoided by structuring patch B as a set of alternative rpms B-with-A and B-without-A and having a patch installer choose the correct alternative based on which other patches are installed.

One may use this invention with any package management tool in place of “rpm”, such as “dpkg”, “tar”, “cpio”, or “zip”. One may use this invention with any file system representation (copy-on-write read-only file system, copy-on-write read-only loopback-mounted file-system-in-a-file, tar, etc.).

Patch activation may be accomplished as follows:

(1) transfer patch to
/mnt/flash/patches/7.11.0/PhyAeluros.i386.rpm
(2) run the commands:
mount -o remount,rw /
rpm -v -U --force /mnt/flash/patches/7.11.0/PhyAeluros.i386.rpm
mount -o remount,ro /

In this preferred embodiment, the patch activation process both arranges for the patch to apply on next boot, and also updates the live image to include the effects of the patch.

The rpm file may include activation scripts that run as part of activating the patch (“% post rules”). For example, activation scripts that may be required to restart any processes affected by the patch. The “rpm -v -U” command above runs these scripts if present.

Patch deactivation may be accomplished as follows:

(1) remove patch from
/mnt/flash/patches/7.11.0/PhyAeluros.i386.rpm
(2) for each file named in the patch, restore the file's content from the original boot image.
(3) run deactivation scripts (if any) stored in the patch (for example, to restart any processes that were downgraded as part of deactivating the patch).

By way of illustration, below is a specific example of an actual patch to Arastra EOS (Aros-2007.1):

% ls -lR
.:
total 8
drwxrwxr-x 3 arastra arastra 4096 Oct 12 12:18 patches
-rwxrwxrwx 1 arastra arastra 147 Oct 12 12:19 rc.aros
./patches:
total 4
drwxrwxr-x 2 arastra arastra 4096 Oct 12 12:19 7.11.0
./patches/7.11.0:
total 812
-rw-r--r-- 1 arastra arastra 824512 Oct 12 12:19 PhyAeluros-1.1.1-
26497.4910.i386.rpm
% cat rc.aros
#!/bin/sh
mount -o remount,rw /
echo “Applying patches for release 7.11.0”
rpm -v -U --force /mnt/flash/patches/7.11.0/*.rpm
mount -o remount,ro /
% rpm -qip patches/7.11.0/PhyAeluros-1.1.1-26497.4910.i386.rpm

| Name | : PhyAeluros | Relocations: /usr |
|---|---|---|
| Version | : 1.1.1 | Vendor: eng@arastra.com |
| Release | : 26497.4910 | Build Date: Thu 11 Oct 2007 |

10:05:46 PM PDT

| | | |
|---|---|---|
| Install Date | : (not installed) | Build Host: bs15-lwr.arastra.com |
| Group | : dev/Arastra | Source RPM: PhyAeluros-1.1.1- |

26497.4910.src.rpm

| | | |
|---|---|---|
| Size | : 2978862 | License: Arastra |
| Signature | : (none) | |

| | |
|---|---|
| URL | : http://www.arastra.com |
| Summary | : PhyAeluros |
| Description | : |

Support for the Aeluros phy chips (AEL1003 and AEL2005).
% rpm -qlp patches/7.11.0/PhyAeluros-1.1.1-26497.4910.i386.rpm
/usr/bin/PhyAeluros
/usr/bin/phyael
/usr/bin/showlinks
/usr/lib/libHwPhyAeluros.so
/usr/lib/libHwPhyAeluros.so.0
/usr/lib/libHwPhyAeluros.so.0.0.0
/usr/lib/libInvPhyAeluros.so
/usr/lib/libInvPhyAeluros.so.0
/usr/lib/libInvPhyAeluros.so.0.0.0
/usr/lib/libPhyAelurosAgent.so
/usr/lib/libPhyAelurosAgent.so.0
/usr/lib/libPhyAelurosAgent.so.0.0.0
/usr/lib/LibPhyAelurosDiag.so
/usr/lib/libPhyAelurosDiag.so.0
/usr/lib/libPhyAelurosDiag.so.0.0.0
/usr/lib/python2.4/site-packages/Ael1003BConstants.py
/usr/lib/python2.4/site-packages/Ael1003BConstants.pyc
/usr/lib/python2.4/site-packages/Ael1003BConstants.pyo
/usr/lib/python2.4/site-packages/Ael2005CConstants.py
/usr/lib/python2.4/site-packages/Ael2005CConstants.pyc
/usr/lib/python2.4/site-packages/Ael2005CConstants.pyo
/usr/lib/python2.4/site-packages/FruPlugin/PhyAelurosFru.py
/usr/lib/python2.4/site-packages/FruPlugin/PhyAelurosFru.pyc
/usr/lib/python2.4/site-packages/FruPlugin/PhyAelurosFru.pyo
/usr/lib/python2.4/site-packages/PhyAelurosAgent.py
/usr/lib/python2.4/site-packages/PhyAelurosAgent.pyc
/usr/lib/python2.4/site-packages/PhyAelurosAgent.pyo
/usr/lib/python2.4/site-packages/SysdbPlugin/SysdbPhyAeluros.py
/usr/lib/python2.4/site-packages/SysdbPlugin/SysdbPhyAeluros.pyc
/usr/lib/python2.4/site-packages/SysdbPlugin/SysdbPhyAeluros.pyo
/usr/lib/tacc/map.d/PhyAeluros.map
%

1. A computing apparatus comprising a digital microprocessor, random access memory, input/output interfaces, a first flash memory, and second flash memory, wherein the first flash memory contains a boot loader, and wherein the second flash memory contains a base operating system file system image archive and multiple operating system patches stored separately from the base operating system file system image archive, wherein the boot loader comprises instructions to install the base operating system file system, and install the multiple operating system patches over the installed base operating system file system.

2. The computing apparatus of claim 1, wherein the boot loader comprises instructions to install a selected set of the operating system patches at boot time based on patch configurations.

3. The computing apparatus of claim 1, where the image is a file-system-in-a-file, and the patch is a set of updates to files within the image file system.

4. The computing apparatus of claim 1, where the patch is represented as an RPM or a set of RPMs.

5. A method for booting a computer operating system, the method comprising loading from a first flash memory to a random access memory a boot loader; executing the boot loader; and executing an operating system kernel; wherein executing the boot loader comprises loading from a second flash memory to a random access memory an operating system file system image archive, installing the operating system file system image archive as a root file system; loading from the second flash memory multiple operating system patches stored separately from the base operating system file system image archive, installing the multiple operating system patches over the root file system.

6. The method of claim 5 wherein installing the multiple operating system patches over the root file system comprises selectively installing patches based on patch configuration information.

7. The method of claim 5 further comprising, if an inactive patch is activated after booting, applying the patch to the root file system.

8. The method of claim 5 further comprising, if an active patch is deactivated after booting, reverting files affected by the patch in the root file system.

9. The method of claim 5 wherein executing the boot loader comprises loading and executing an initialization script, wherein the initialization script comprises instructions to perform the loading of the operating system file system image archive, the installing of the operating system file system image archive as a root file system, the loading of the multiple operating system patches, and the installing of the multiple operating system patches over the root file system.

10. A computing apparatus comprising a digital microprocessor, random access memory, input/output interfaces, a first flash memory, and second flash memory, wherein the first flash memory contains a boot loader, and wherein the second flash memory contains a base operating system file system image archive and multiple operating system patches stored separately from the base operating system file system image archive, wherein the boot loader comprises instructions to load and execute initialization scripts, wherein the initialization scripts comprise instructions to install the base operating system file system, and install the multiple operating system patches over the installed base operating system file system.
